(19) United States
(12) Patent Application Publication
(10) Pub. No.: US 2020/0257762 A1
(43) Pub. Date: Aug. 13, 2020

(54) TEXT CLASSIFICATION AND SENTIMENTIZATION WITH VISUALIZATION

(71) Applicant: Royal Caribbean Cruises Ltd., Miami, FL (US)

(72) Inventors: Arya Eskamani, Miami, FL (US); Mallori Harrell, Miami, FL (US); Gracie Diaz, Coral Gables, FL (US); Victor Plaza, Miami, FL (US)

(21) Appl. No.: 16/271,445

(22) Filed: Feb. 8, 2019

(51) Int. Cl. G06F 17/27; G06N 20/00; G06T 11/60

(52) U.S. Cl. CPC G06F 17/2775; G06T 2200/24; G06T 11/60; G06N 20/00

(57) ABSTRACT

A text classification method includes loading a corpus of text that different words organized as different collections of comments and concurrently submitting each of the comments to a topic modeler and a sentiment analysis engine, and receiving for each of the comments, a set of topics likely to be associated with a corresponding one of the comments and an associated sentiment. Then, a visualization is generated of each of the comments, and each of the comments are represented in the visualization with a respective graphical image. Groups of the graphical images are clustered according to topic common to associated ones of the comments, arranged by sentiment, and a corresponding common topic is displayed in connection with each clustered group. In response to an activation of one of the graphical images, at least a portion of a represented one of the comments are displayed in a window of the user interface.

### BACKGROUND OF THE INVENTION

### Field of the Invention

The present invention relates to the field text classification and more particularly to processing randomly presented text in order to determine a topic.

### Description of the Related Art

In the travel and hospitality industry, the customer experience remains the predominant indicator of customer retention. Customers who have enjoyed a positive experience with a provider are most likely to become repeat customers, whereas customers who have enjoyed a negative experience with a provider are most likely to seek out a new provider. In most industries, maintaining an awareness of the customer experience is a task little more sophisticated than soliciting feedback from the customer at the point of service. Thus, in the airline industry or hotel industry, the guest simply completes a comment card at the conclusion of the trip or stay. But, customer experience determination in the cruise ship industry presents a much more complex problem.

Specifically, in the cruise ship industry, the cruise line, is each at the same time, that of a hotel, a transportation company, a multiplicity of restaurants and a tour operator. In many instances, there are different mechanisms for individual guests to provide customer feedback. The mechanisms run the gamut from manual comment cards, to e-mails, to text messages, to Web site forms to mobile application forms. In many instances, the computing systems which collect customer feedback are different and independent from one another. As such, presenting an aggregate view of the total customer experience for a cruise ship heretofore has not been possible.

### BRIEF SUMMARY OF THE INVENTION

Embodiments of the present invention address deficiencies of the art in respect to text analysis and provide a novel and non-obvious method, system and computer program product for text classification and sentiment analysis. In one embodiment of the invention, a method for text classification includes loading into memory of a computer, a corpus of text that includes a multiplicity of different words organized as different collections of comments and concurrently submitting each of the comments to a topic modeler trained to produce a set of topics likely to be present in submitted text and to a sentiment analysis engine trained to identify a sentiment of the submitted text, and receiving in return, for each of the comments, a set of one or more topics likely to be associated with a corresponding one of the comments and an associated sentiment. The method additionally, includes generating a visualization in a user interface of a display of the computer of each of the comments, representing each of the comments in the visualization with a respective graphical image, clustering groups of the graphical images according to topic that is common to associated ones of the comments, arranging each cluster of the graphical images according to different associated sentiments, and displaying in connection with each clustered one of the groups, a corresponding common topic, and in response to an activation of one of the respective graphical images, displaying in a window of the user interface at least a portion of a represented one of the comments.

In one aspect of the embodiment, the method includes prompting in the user interface for a file location of a database containing the corpus of text, specifying in the user interface different column names for the database and performing the loading from the database utilizing the column names. In another aspect of the embodiment, the method additionally includes performing lemmatization of each of the comments prior to submitting the comments to the topic modeler and sentiment analysis engine. In yet another aspect of the embodiment, the method performing part-of-speech tagging of each of the comments prior to submitting the comments to the topic modeler and sentiment analysis engine. In even yet another aspect of the embodiment, the method includes performing term-frequency/inverse document frequency filtering of each of the comments prior to submitting the comments to the topic modeler and sentiment analysis engine. Finally, in yet another aspect of the embodiment, the method includes identifying from the topic modeler, a dominant topic for each corresponding one of topics and, on the condition that for a particular one of the comments, no topic is found to be dominant, prompting in the user interface for manual training of the topic modeler with a labeled form of the particular one of the comments.

In another embodiment of the invention, a text classification data processing system includes a host computing system that includes one or more computers, each with memory and at least one processor. The system additionally includes a topic modeler executing in the host computing system, the topic modeler receiving a corpus of text and characterizing the text according to one or more topics based upon a pre-established topic model. The system even further includes a sentiment analysis engine also executing in the host computing system, the engine processing the corpus of text to detect a sentiment reflected by the text. Finally, the system includes a text classification module also executing in the host computing system.

The module includes computer program instructions enabled during execution to perform loading into the memory of the host computing system, a corpus of text comprising a multiplicity of different words organized as different collections of comments and concurrently submitting each of the comments the topic modeler to produce a set of topics likely to be present in submitted text and also to the sentiment analysis engine to identify a sentiment of the submitted text, and receiving from the topic modeler, for each of the comments, a set of one or more topics likely to be associated with a corresponding one of the comments, and from the sentiment analysis engine an associated sentiment. The method yet further includes generating a visualization in a user interface of a display of the host computing system of each of the comments, representing each of the comments in the visualization with a respective graphical image and clustering groups of the graphical images according to topic that is common to associated ones of the comments as determined by the topic modeler, arranging each cluster of the graphical images according to different associated sentiments, and displaying in connection with each clustered one of the groups, a corresponding common topic. Finally, the method includes responding to an activation of one of the respective graphical images by displaying in a window of the user interface at least a portion of a represented one of the comments.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a process for text classification of comments;

FIG. 2 is a schematic illustration of a data processing system configured for text classification of comments; and,

FIG. 3 is a flow chart illustration of a process for text classification of comments.

### DETAILED DESCRIPTION OF THE INVENTION

Embodiments of the invention provide for text classification of different comments, received, for example, from different operational departments of a cruise line including lodging, food and beverage, shipboard entertainment and port excursions. The comments are natural language pre-processed by way of special characters and stop words removal, lemmatization, part of speech tagging, term frequency and inverse document frequency and bag of words operations. The pre-processed corpus of comments is then submitted to either or both of a topic modeler and also a sentiment analysis engine, depending upon a pre-specified user preference. The topic modeler, performing latent dirichlet allocation (LDA) topic modeling, generates a topic model for the corpus in terms of different weighted topics for each comment, with a most heavily weighted topic as the pre-dominant topic for the comment, and a least heavily weighted topic as the lease dominant topic for the comment. The sentiment analysis engine, in turn, returns a sentiment for each topic ranging from favorable to unfavorable. The sentiment may be represented as a value on a continuous scale, or a value on a discrete scale of a limited number of defined sentiments ranging from positive, to neutral, to negative.

Thereafter, each comment can be included in a table with a corresponding set of topics and weights, and an associated sentiment. The table then is processed to place a graphical icon in a user interface display, with icons of common topic clustered together, and icons of a common topic sharing a similar appearance. The icons for each common topic, optionally, are further arranged according to sentiment. Alternatively, an aggregate sentiment may be computed, for instance by averaging all sentiments for all related comments of the common topic, and displayed in connection with the topic label for the icons grouped thereby. Of note, each of the icons is activatable in the user interface such that the selection of any one of the icons results in a display in a separate window from the user interface of the associated comment and the indicated sentiment and the listing of associated topics. In this way, in a single dashboard view, one is able to view and digest the customer experience in a multi-departmental operation such as a cruise line so as to understand the range and intensity of relevant topics of interest in customer feedback and the sentiment for each of the topics.

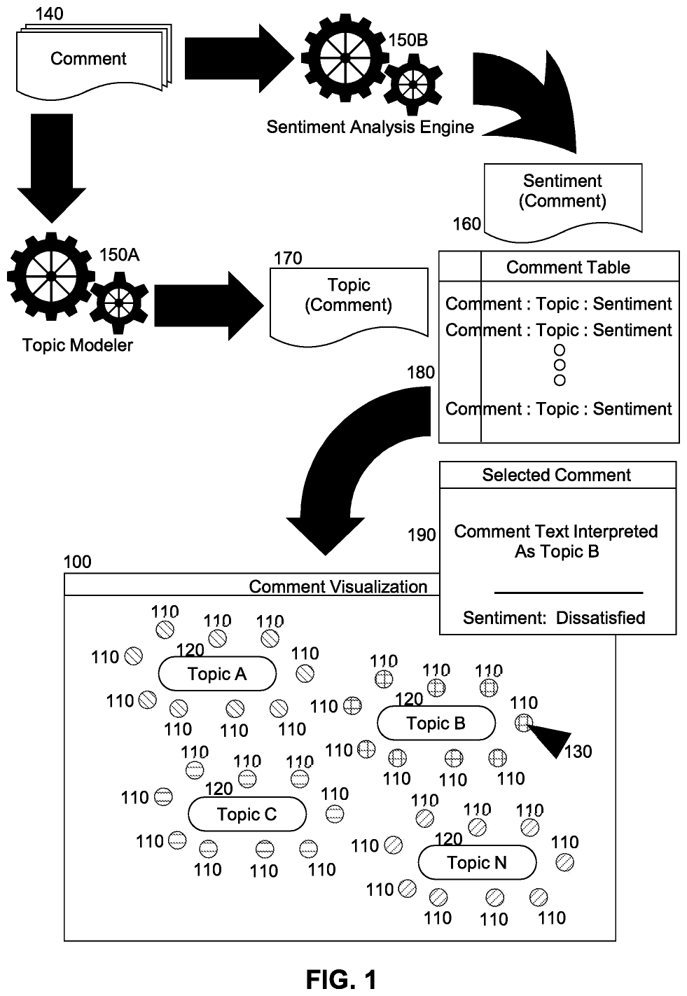

In further illustration, FIG. 1 is pictorial illustration of a process for text classification of comments. As shown in FIG. 1, a corpus of comments 140 are received for topic modeling and sentiment analysis. The comments 140 stem from customer provided feedback for various departments of a cruise line operation, including embarkation and debarkation, food and beverage, onboard entertainment and on-shore excursions, to name only a few examples. The comments 140 are received through a variety of methodologies ranging from written comment cards to postings to social media, but ultimately, all of the comments 140 are captured and stored in a database according to a specified schema for comment storage.

The comments 140 are then submitted dually to both a topic modeler 150A and also a sentiment analysis engine 150B. The sentiment analysis engine 150B is a separately executing computer program that receives as input a body of text and provides as an output, a label for the text specifying whether or not the text is positive, negative or neutral in sentiment. To that end, the sentiment analysis engine 150B may be driven by a deep neural network trained through multiple rounds of gradient descent on training data of known sentiment so as to minimize the learning rate towards ground truth. The topic modeler 150A, in turn, is a statistical modeler that correlates the presence of particular words in a body of text with a specified topic so that upon submission of a body of text, a range of one or more topics associated with the text are output along with a weighting value indicating a pre-dominance of each of the topics in the output.

In response to the submission of the comments 140 to the topic modeler 150A, a topic or set of weighted topics 170 are produced and inserted into a comment table 180 sorted by comment. Likewise, in response to the submission of the comments 140 to the sentiment analysis engine 150B, a sentiment value 160 is produced and also inserted into the comment table 180 in association with the comment. Thereafter, a comment visualization user interface 100 is generated with an activatable graphical icon 110 for each of the comments 140, with the activatable graphical icons 110 being clustered together in the user interface 100 by common topic. For instance, the comment visualization user interface 100 may utilize a t-distributed stochastic neighbor embedding (TSNE) calculation to form comment clusters. To that end, a label 120 for each common topic may be positioned in the user interface 100 amongst the clustered groups of activatable graphical icons 110.

Importantly, each of the activatable graphical icons 110 may be activated through selection by a pointing device 130. As such, upon activation, a comment corresponding to the selected one of the activatable icons 110 may be determined. The text of the corresponding comment is then displayed in a separate window 190 from that of the comment visualization user interface 100. The separate window 190 may include the text of the comment, a listing of associated topics, and a sentiment label assigned to the text of the comment.

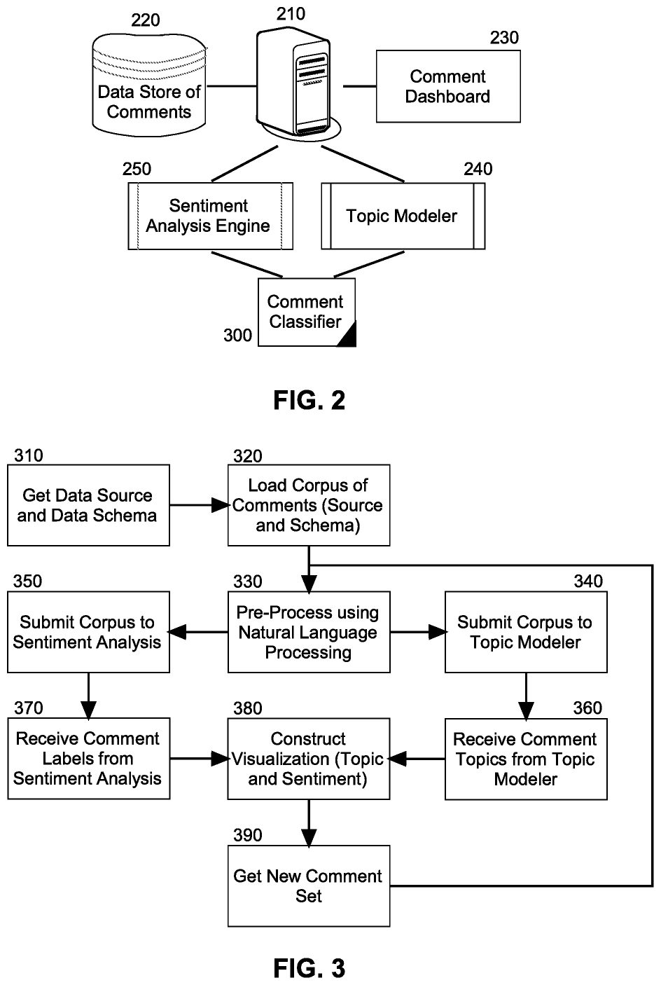

The process described in connection with FIG. 1 may be implemented within a data processing system. In further illustration, FIG. 2 schematically shows a data processing system configured for text classification of comments. The system includes a host computing system 210 that includes one or more computers, each with memory and at least one processor. The host computing system 210 supports the execution in memory thereof, of both a topic modeler 240, and a sentiment analysis engine 250. The topic modeler 240 is a computer program adapted statistical modeling by discovering abstract topics that occur in a collection of documents. An LDA topic model is used to classify text in a document to a particular topic which then builds a topic per document model and words per topic model, modeled as Dirichlet distributions. The sentiment analysis engine 250, in turn, a computer program that employs natural language processing, text analysis and computational linguistics to systematically identify, extract, quantify, and study affective states and subjective information in order to label submitted text according to one or several sentiments. Optionally, the sentiment analysis engine 250 may employ a deep neural network trained upon a corpus of text to predict an associated sentiment.

Of note, the system includes a comment classification module 300. The comment classification module 300 includes computer program instructions adapted to execute in the memory of the host computing platform 210. The instructions are enabled during execution to locate in a data store of comments 220 a set of comments organized according to a known schema and to submit the comments to the topic modeler 240 and the sentiment analysis engine 250. The instructions are further enabled to process the output from each of the topic modeler 240 and the sentiment analysis engine 250 in a comment dashboard 230 which presents different activatable graphical icons clustered together according to common topic which when activated, cause the rendering of a separate window with the text of a corresponding comment and its labeled sentiment.

In even yet further illustration of the operation of the comment classification module 300, FIG. 3 is a flow chart illustration of a process for text classification of comments. Beginning in block 310, a data source for comments is specified along with a schema for the data in the data source. In block 320, a corpus of comments are retrieved into memory from the data source according to the schema and in block 330, the corpus of comments are pre-processed. The pre-processing of block 330 includes the removal of special characters and stop words. The pre-processing of block 330 also includes lemmatization and part of speech tagging. The pre-processing of block 330 yet further includes term frequency inverse document frequency dampening so as to remove from consideration or lessen the impact of different words in each of the comments of the corpus that appear with high frequency. Finally, the pre-processing includes bag of words determination by counting an appearance of each word in each comment.

Subsequent to the pre-processing of block 330, the pre-processed set of comments are dually submitted to each of a topic model in block 340, and a sentiment analysis engine in block 350. In block 360, the output of the topic modeler is received, and in block 370, concurrently, the output of the sentiment analysis engine is received. Thereafter, in block 380 a visualization is constructed and displayed in the user interface by creating activatable graphical icons for each of the comments, and then clustering groups of the activatable graphical icons according to common topic. Finally, in block 390, a new set of comments are loaded and the process repeats through block 330. In this way, one may view an entire landscape of customer experience feedback across a multi-operational business such as a cruise line, readily identifying the pre-dominant topics of interest and associated sentiment for each of the topics, while maintaining an ability to drill down on any one comment of any one topic.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A text classification method comprising:
loading into memory of a computer, a corpus of text comprising a multiplicity of different words organized as different collections of comments;
concurrently submitting each of the comments to a topic modeler trained to produce a set of topics likely to be present in submitted text and a sentiment analysis engine trained to identify a sentiment of the submitted text, and receiving from the topic modeler, for each of the comments, a set of one or more topics likely to be associated with a corresponding one of the comments and, from the sentiment analysis engine, an associated sentiment; and,
generating a visualization in a user interface of a display of the computer of each of the comments;
representing each of the comments in the visualization with a respective graphical image;
clustering groups of the graphical images according to topic that is common to associated ones of the comments as determined by the topic modeler, arranging each cluster of the graphical images according to different associated sentiments, and displaying in connection with each clustered one of the groups, a corresponding common topic; and,
responsive to an activation of one of the respective graphical images, displaying in a window of the user interface at least a portion of a represented one of the comments.

2. The method of claim 1, further comprising:
prompting in the user interface for a file location of a database containing the corpus of text;
specifying in the user interface different column names for the database; and,
performing the loading from the database utilizing the column names.

3. The method of claim 1, further comprising performing lemmatization of each of the comments prior to submitting the comments to the topic modeler and sentiment analysis engine.

4. The method of claim 1, further comprising performing part-of-speech tagging of each of the comments prior to submitting the comments to the topic modeler and sentiment analysis engine.

5. The method of claim 1, further comprising performing term-frequency/inverse document frequency filtering of each of the comments prior to submitting the comments to the topic modeler and sentiment analysis engine.

6. The method of claim 1, further comprising:
identifying from the topic modeler, a dominant topic for each corresponding one of topics; and,
on condition that for a particular one of the comments, no topic is found to be dominant by topic modeler, prompting in the user interface for manual training of the topic modeler with a labeled form of the particular one of the comments.

7. A text classification data processing system comprising:
a host computing system comprising one or more computers, each with memory and at least one processor;
a topic modeler executing in the host computing system, the topic modeler receiving a corpus of text and characterizing the text according to one or more topics based upon a pre-established topic model;
a sentiment analysis engine also executing in the host computing system, the engine processing the corpus of text to detect a sentiment reflected by the text; and,
a text classification module also executing in the host computing system, the module comprising computer program instructions enabled during execution to perform:
loading into the memory of the host computing system, a corpus of text comprising a multiplicity of different words organized as different collections of comments;
concurrently submitting each of the comments the topic modeler to produce a set of topics likely to be present in submitted text and also to the sentiment analysis engine to identify a sentiment of the submitted text, and receiving from the topic modeler, for each of the comments, a set of one or more topics likely to be associated with a corresponding one of the comments, and from the sentiment analysis engine an associated sentiment;
generating a visualization in a user interface of a display of the host computing system of each of the comments;
representing each of the comments in the visualization with a respective graphical image;
clustering groups of the graphical images according to topic that is common to associated ones of the comments as determined by the topic modeler, arranging each cluster of the graphical images according to different associated sentiments, and displaying in connection with each clustered one of the groups, a corresponding common topic; and,
responsive to an activation of one of the respective graphical images, displaying in a window of the user interface at least a portion of a represented one of the comments.

8. The system of claim 7, wherein the program instructions are further enabled to perform:
prompting in the user interface for a file location of a database containing the corpus of text;
specifying in the user interface different column names for the database; and,
performing the loading from the database utilizing the column names.

9. The system of claim 7, wherein the program instructions are further enabled to perform lemmatization of each of the comments prior to submitting the comments to the topic modeler and the sentiment analysis engine.

10. The system of claim 7, wherein the program instructions are further enabled to perform part-of-speech tagging of each of the comments prior to submitting the comments to the topic modeler and sentiment analysis engine.

11. The system of claim 7, wherein the program instructions are further enabled to perform term-frequency/inverse document frequency filtering of each of the comments prior to submitting the comments to the topic modeler and sentiment analysis engine.

12. The system of claim 7, wherein the program instructions are further enabled to perform:
identifying from the topic modeler, a dominant topic for each corresponding one of topics; and,
on condition that for a particular one of the comments, no topic is found to be dominant by the topic modeler, prompting in the user interface for manual training of the topic modeler with a labeled form of the particular one of the comments.

13. A computer program product for text classification, the computer program product including a computer readable storage medium having program instructions embodied therewith, the program instructions executable by a device to cause the device to perform a method including:
loading into memory of a computer, a corpus of text comprising a multiplicity of different words organized as different collections of comments;
concurrently submitting each of the comments to a topic modeler trained to produce a set of topics likely to be present in submitted text and a sentiment analysis engine trained to identify a sentiment of the submitted text, and receiving from the topic modeler, for each of the comments, a set of one or more topics likely to be associated with a corresponding one of the comments and, from the sentiment analysis engine, an associated sentiment; and,
generating a visualization in a user interface of a display of the computer of each of the comments;
representing each of the comments in the visualization with a respective graphical image;
clustering groups of the graphical images according to topic that is common to associated ones of the comments as determined by the topic modeler, arranging each cluster of the graphical images according to different associated sentiments, and displaying in connection with each clustered one of the groups, a corresponding common topic; and,
responsive to an activation of one of the respective graphical images, displaying in a window of the user interface at least a portion of a represented one of the comments.

14. The computer program product of claim 13, wherein the method further comprises:
prompting in the user interface for a file location of a database containing the corpus of text;
specifying in the user interface different column names for the database; and,
performing the loading from the database utilizing the column names.

15. The computer program product of claim 13, wherein the method further comprises performing lemmatization of each of the comments prior to submitting the comments to the topic modeler and the sentiment analysis engine.

16. The computer program product of claim 13, wherein the method further comprises performing part-of-speech tagging of each of the comments prior to submitting the comments to the topic modeler and the sentiment analysis engine.

17. The computer program product of claim 13, wherein the method further comprises performing term-frequency/inverse document frequency filtering of each of the comments prior to submitting the comments to the topic modeler and the sentiment analysis engine.

18. The computer program product of claim 13, wherein the method further comprises:
identifying from the topic modeler, a dominant topic for each corresponding one of topics; and,
on condition that for a particular one of the comments, no topic is found to be dominant by the topic modeler, prompting in the user interface for manual training of the topic modeler with a labeled form of the particular one of the comments.
